(19) United States
(12) Patent Application Publication
(10) Pub. No.: US 2021/0056991 A1
(43) Pub. Date: Feb. 25, 2021

(54) MAGNETIC TAPE, MAGNETIC TAPE CARTRIDGE, AND MAGNETIC RECORDING AND REPRODUCING APPARATUS

(71) Applicant: FUJIFILM Corporation, Tokyo (JP)

(72) Inventors: Takashi IMAI, Minami-ashigara-shi (JP); Kazutoshi KATAYAMA, Minami-ashigara-shi (JP)

(73) Assignee: FUJIFILM Corporation, Tokyo (JP)

(21) Appl. No.: 16/995,907

(22) Filed: Aug. 18, 2020

(30) Foreign Application Priority Data
Aug. 19, 2019 (JP) 2019-149950

(51) Int. Cl. G11B 5/706; G11B 5/714; G11B 5/008; G11B 5/735; G11B 5/708

(52) U.S. Cl. CPC G11B 5/70678; G11B 5/714; G11B 5/7085; G11B 5/735; G11B 5/00813

(57) ABSTRACT

The magnetic tape includes: a non-magnetic support; and a magnetic layer including ferromagnetic powder, in which a change amount of a loss tangent tan δ at a measurement temperature in a range of 50° C. to 100° C. before and after heating at 70° C. for 10 hours is 0.000 or more and 0.012 or less.

### CROSS-REFERENCE TO RELATED APPLICATIONS

This application claims priority under 35 U.S.C. 119 to Japanese Patent Application No. 2019-149950 filed on Aug. 19, 2019. The above application is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic recording and reproducing apparatus.

### 2. Description of the Related Art

A magnetic tape usually has a configuration in which a magnetic layer is formed on a non-magnetic support (for example, see JP2007-048427A).

### SUMMARY OF THE INVENTION

Recording and reproduction of data on a magnetic tape are usually performed as follows. A magnetic tape cartridge accommodating a magnetic tape wound around a reel is set in a magnetic recording and reproducing apparatus called a drive, and the magnetic tape is run by feeding and winding of the magnetic tape in the drive. Recording of data on a magnetic layer and reproducing of the recorded data are performed by causing a surface of the running magnetic tape (magnetic layer surface) and a magnetic head provided in the drive to come into contact with each other to be slid on each other.

During the running as described above, since tension is applied to the magnetic tape, the magnetic tape is in a state where a stress is applied. Also, even while the magnetic tape is stored in a state of being wound around a reel and accommodated in the magnetic tape cartridge, a stress is applied to the magnetic tape. It is desirable to suppress deformation of the magnetic tape that may be caused by application of a stress during use and/or storage in order to increase a reliability of the magnetic tape as a data storage medium. This is for the following reason, for example. Recording of data on the magnetic tape is usually performed by recording a magnetic signal in a data band of the magnetic tape. Thereby, a data track is formed in the data band. On the other hand, in a case of reproducing the recorded data, the magnetic signal recorded on the data track is read by causing the magnetic head to follow the data track of the magnetic tape in the drive. Here, as an accuracy with which the magnetic head follows the data track is higher, occurrence of a reproduction error can be suppressed, and a reliability of the magnetic tape as a data storage medium can be increased. However, in a case where the magnetic tape is greatly deformed after data recording, the accuracy with which the magnetic head follows the data track during data reproduction is reduced, and a reproduction error is likely to occur. For this reason, for example, it is desirable to suppress deformation of the magnetic tape that may be caused by application of a stress during use and/or storage.

An aspect of the present invention provides for a magnetic tape capable of suppressing deformation during use and/or storage.

An aspect of the present invention relates to a magnetic tape comprising: a non-magnetic support; and a magnetic layer including ferromagnetic powder, in which a change amount Δ1 of a loss tangent tan δ at a measurement temperature in a range of 50° C. to 100° C. before and after heating at 70° C. for 10 hours is 0.000 or more and 0.012 or less.

In an embodiment, the magnetic tape may have the magnetic layer on one surface side of the non-magnetic support and has a back coating layer including non-magnetic powder on the other surface side, and a change amount Δ2 obtained by the following formula is 0.000 or more and 0.020 or less.

Δ2=Δa×[Da/(Da+Db)]+Δb×[Db/(Da+Db)]

In the formula, Da is a thickness of a portion on the magnetic layer side on the non-magnetic support, Δa is a change amount of a loss tangent tan δ of the portion on the magnetic layer side at a measurement temperature in a range of 50° C. to 100° C. before and after the heating, Db is a thickness of a portion on the back coating layer side on the non-magnetic support, and Δb is a change amount of a loss tangent tan δ of the portion on the back coating layer side at a measurement temperature in a range of 50° C. to 100° C. before and after the heating.

A unit of the thickness Da may be the same as a unit of the thickness Db, and may be, for example, μm or nm.

In an embodiment, the thickness Da of the portion on the magnetic layer side may be 0.20 μm or more and 0.50 μm or less, and the thickness Db of the portion on the back coating layer side may be 0.20 μm or more and 1.50 μm or less.

In an embodiment, the thickness Da of the portion on the magnetic layer side may be 0.20 μm or more and 1.00 μm or less, and the thickness Db of the portion on the back coating layer side may be 0.20 μm or more and 0.90 μm or less.

In an embodiment, the magnetic tape may further comprise a non-magnetic layer including non-magnetic powder between the non-magnetic support and the magnetic layer.

In an embodiment, the back coating layer may include one or more types of non-magnetic powder selected from the group consisting of inorganic powder and carbon black.

In an embodiment, the ferromagnetic powder may be hexagonal ferrite powder.

In an embodiment, the ferromagnetic powder may be ε-iron oxide powder.

Another aspect of the present invention relates to a magnetic tape cartridge comprising: the magnetic tape described above.

Another aspect of the present invention relates to a magnetic recording and reproducing apparatus comprising: the magnetic tape described above; and a magnetic head.

According to an aspect of the present invention, it is possible to provide a magnetic tape capable of suppressing deformation during use and/or storage. In addition, according to an embodiment of the present invention, it is possible to provide a magnetic tape cartridge and a magnetic recording and reproducing apparatus including the magnetic tape.

### DESCRIPTION OF THE PREFERRED EMBODIMENTS

### Magnetic Tape

An aspect of the present invention relates to a magnetic tape comprising: a non-magnetic support; and a magnetic layer including ferromagnetic powder, in which a change amount Δ1 of a loss tangent tan δ at a measurement temperature in a range of 50° C. to 100° C. before and after heating at 70° C. for 10 hours is 0.000 or more and 0.012 or less.

Hereinafter, the magnetic tape will be described more specifically.

### Change Amount of Loss Tangent tan δ

In the magnetic tape, a change amount Δ1 of a loss tangent tan δ at a measurement temperature in a range of 50° C. to 100° C. before and after heating at 70° C. for 10 hours is 0.000 or more and 0.012 or less. The change amount Δ1 is a value obtained by the following method.

A plurality of samples having a length of 50.0 mm and a width of 3.4 mm are cut out from a magnetic tape to be measured in a longitudinal direction. One sample (hereinafter, referred to as a “sample with heating”.) is placed in a thermal treatment atmosphere at an atmosphere temperature of 70° C. (absolute humidity: 0.014 kg/kg D.A. (Dry Air) or less) for 10 hours and heated, another one sample (hereinafter, referred to as a “sample without heating”.) is not heated, and then each was fixed to a dynamic viscoelasticity measuring device so that a distance between chucks is 10.0 mm. The atmosphere temperature of the thermal treatment atmosphere of 70° C. is, specifically, a temperature in a range of 69.5° C. or more and 70.4° C. or less. The same applies to heating in a case of obtaining Δa and Δb. The measurement is performed on each sample under the following measurement conditions, and a storage elastic modulus and a loss elastic modulus are obtained at each measurement temperature at a temperature interval of 0.5° C. to 2.0° C. in a range of 50° C. to 100° C. Specifically, a minimum temperature of the measurement temperature is a temperature in a range of 49.5° C. or more and 50.4° C. or less, and a maximum temperature of the measurement temperature is a temperature in a range of 99.5° C. or more and 100.4° C. or less. The measurement temperature is an atmosphere temperature near the sample in the dynamic viscoelasticity measuring device. During the measurement, a set temperature of the dynamic viscoelasticity measuring device is heated from −20.0° C. to 200.0° C. at a heating rate of 2.0° C./min. The loss tangent tan δ is obtained by “tan δ=loss elastic modulus/storage elastic modulus”. As the dynamic viscoelasticity measuring device, for example, DMS6100 manufactured by Hitachi High-Tech Science Corporation can be used. For each measurement temperature, “(tan δ of sample without heating)−(tan δ of sample with heating)” is obtained, and a maximum value of “(tan δ of sample without heating)−(tan δ of sample with heating)” obtained at each measurement temperature in a range of 50° C. to 100° C. is defined as the change amount Δ1 of the loss tangent tan δ at the measurement temperature in a range of 50° C. to 100° C.

### Measurement Condition

Measurement mode: tension

Frequency: 1 Hz (Hertz)

Strain amplitude: 0.1%

Scan temperature: −20.0° C. to 200.0° C.

The present inventor has made intensive studies, and as a result, it was found that the change amount Δ1 of tan δ obtained by the above-described method is correlated with deformation of a magnetic tape during use and/or storage, that is, in a state where a stress is applied. It is considered that a small change amount of tan δ before and after the heating means that a viscous fluidity is smaller than an elasticity, and the present inventor supposes that this contributes to suppression of a dynamical time change (deformation) with time under application of a stress. However, this is merely supposition and does not limit the present invention. As a result of further intensive studies, the present inventor has newly found that deformation of a magnetic tape during use and/or storage can be suppressed by controlling a viscoelastic property of the magnetic tape so that the change amount Δ1 of tan δ obtained by the above-described method is 0.000 or more and 0.012 or less. On the other hand, JP2007-048427A only discloses a loss elastic modulus of 0.5 Hz at a temperature of 130° C., but does not disclose a change amount of tan δ before and after the heating.

In the magnetic tape, the change amount Δ1 of the loss tangent tan δ at a measurement temperature in a range of 50° C. to 100° C. before and after heating at 70° C. for 10 hours is 0.000 or more and 0.012 or less. From a viewpoint of suppressing deformation during running and/or storage, the change amount Δ1 is 0.012 or less, and from a viewpoint of further suppressing such deformation, the change amount Δ1 is preferably 0.010 or less, more preferably 0.008 or less, still more preferably 0.006 or less, and still more preferably 0.004 or less. The change amount Δ1 is 0.000 or more, and may be 0.000, and in an aspect, may be 0.001 or more, 0.002 or more, or 0.003 or more.

The change amount Δ1 of the magnetic tape can be controlled, for example, by adjusting viscoelastic properties of various layers provided on a non-magnetic support. A magnetic layer is provided on one surface side of the non-magnetic support. The magnetic layer can be provided directly on the non-magnetic support, or a non-magnetic layer including non-magnetic powder can be provided between the non-magnetic support and the magnetic layer. A back coating layer including non-magnetic powder can be provided on a surface side of the non-magnetic support opposite to a surface side having the magnetic layer. As an example of means for controlling the change amount Δ1, in the magnetic tape having the magnetic layer on one surface side of the non-magnetic support and having the back coating layer including non-magnetic powder on the other surface side, a change amount Δ2 calculated by the following formula is adjusted in consideration of respective viscoelastic properties and thicknesses of a portion on the magnetic layer side and a portion on the back coating layer side on the non-magnetic support. The “portion on the magnetic layer side” is a layer provided on the surface of the non-magnetic support having the magnetic layer, and in a case where a plurality of layers are provided, refers to the entirety of these layers. The same applies to the “portion on the back coating layer side”. In an aspect, the change amount Δ2 obtained by the following formula for the portion on the magnetic layer side and the portion on the back coating layer side on the non-magnetic support is preferably 0.000 or more and 0.020 or less.

Δ2=Δa×[Da/(Da+Db)]+Δb×[Db/(Da+Db)]

In the above formula, Da is a thickness of the portion on the magnetic layer side on the non-magnetic support, and Δa is a change amount of the loss tangent tan δ of the portion on the magnetic layer side on the non-magnetic support at a measurement temperature in a range of 50° C. to 100° C. before and after heating the magnetic tape at 70° C. for 10 hours as described above. Db is a thickness of the portion on the back coating layer side on the non-magnetic support, and Δb is a change amount of the loss tangent tan δ of the portion on the back coating layer side at a measurement temperature in a range of 50° C. to 100° C. before and after heating the magnetic tape at 70° C. for 10 hours as described above. The change amount Δ2 is more preferably 0.018 or less, still more preferably 0.016 or less, still more preferably 0.014 or less, still more preferably 0.012 or less, and still more preferably 0.010 or less. The change amount Δ2 may be 0.000 or more, and may be 0.000, and in an aspect, may be 0.001 or more, 0.002 or more, or 0.003 or more.

The change amount Δa is obtained by the following method.

A plurality of samples having a length of 50.0 mm and a width of 3.4 mm are cut out from a magnetic tape to be measured in a longitudinal direction. The portion on the magnetic layer side on the non-magnetic support is removed from each sample. Alternatively, the sample is cut out as described above after the portion on the magnetic layer side on the non-magnetic support is removed. In the magnetic tape having the magnetic layer directly on the non-magnetic support, the portion on the magnetic layer side on the non-magnetic support is the magnetic layer, and in the magnetic tape having the magnetic layer and the non-magnetic layer including non-magnetic powder on the non-magnetic support, the portion is the non-magnetic layer and the magnetic layer. The portion on the magnetic layer side can be removed by a well-known method such as wiping using a solvent.

One of the samples from which the portion on the magnetic layer side is removed on the non-magnetic support (hereinafter, referred to as a “sample with heating subjected to removing”.) is placed in a thermal treatment atmosphere at an atmosphere temperature of 70° C. (absolute humidity: 0.014 kg/kg D.A. or less) for 10 hours and heated, and then a storage elastic modulus and a loss elastic modulus at each measurement temperature in a range of 50° C. to 100° C. are obtained. For each measurement temperature, from a storage elastic modulus E′(T)_{removed product} and a loss elastic modulus E″(T)_{removed product} obtained for the sample with heating subjected to removing, and for the same magnetic tape, a storage elastic modulus E′(T)ₜₐₚₑ and a loss elastic modulus E″(T)ₜₐₚₑ obtained for a sample with heating subjected to measurement without removing the portion on the magnetic layer side to obtain the change amount Δ1, a storage elastic modulus E′(T) and a loss elastic modulus E″(T) of the portion on the magnetic layer side at each measurement temperature are obtained by the following formula. In the following formula, “Dₜₐₚₑ” is a total thickness of the magnetic tape, that is, a thickness of the sample with heating subjected to measurement without removing the portion on the magnetic layer side, “D_{removed product}” is a thickness of the sample from which the portion on the magnetic layer side is removed, that is, a thickness of the magnetic tape excluding the portion on the magnetic layer side. From the storage elastic modulus E′(T) and the loss elastic modulus E″(T) obtained in this way, the loss tangent tan δ at each measurement temperature after the above-described heating is calculated as “tan δ=loss elastic modulus E″(T)/storage elastic modulus E′(T)” for the portion on the magnetic layer side on the non-magnetic support.

Storage elastic modulus E′(T) of portion on magnetic layer side on non-magnetic support=E′(T)ₜₐₚₑ×Dₜₐₚₑ−E′(T)_{removed product}×D_{removed product}/Dₜₐₚₑ−D_{removed product}

Loss elastic modulus E″(T) of portion on magnetic layer side on non-magnetic support=E″(T)ₜₐₚₑ×Dₜₐₚₑ−E″(T)_{removed product}×D_{removed product}/Dₜₐₚₑ−D_{removed product}

Apart from the above-described sample with heating subjected to removing, for another one sample (hereinafter, referred to as a “sample without heating subjected to removing”) of the samples from which the portion on the magnetic layer side is removed on the non-magnetic support, a storage elastic modulus and a loss elastic modulus at each measurement temperature are obtained in the same manner as described above. By using the storage elastic modulus and the loss elastic modulus of the sample without heating subjected to removing obtained in this way, and for the same magnetic tape, a storage elastic modulus and a loss elastic modulus at each measurement temperature obtained for a sample without heating subjected to measurement without removing the portion on the magnetic layer side to obtain the change amount Δ1, the loss tangent tan δ is calculated for the portion on the magnetic layer side on the non-magnetic support in the same manner as the method described for the sample with heating subjected to removing. For each measurement temperature, “(tan δ of sample without heating subjected to removing)−(tan δ of sample with heating subjected to removing)” is obtained, and a maximum value of “(tan δ of sample without heating subjected to removing)−(tan δ of sample with heating subjected to removing)” obtained at each measurement temperature in a range of 50° C. to 100° C. is defined as the change amount Δa of the loss tangent tan δ of the portion on the magnetic layer side on the non-magnetic support at the measurement temperature in a range of 50° C. to 100° C.

In the above calculation formula of Δ2, Db is a thickness of the portion on the back coating layer side on the non-magnetic support, and Δb is a change amount of the loss tangent tan δ of the portion on the back coating layer side at a measurement temperature in a range of 50° C. to 100° C. before and after heating the magnetic tape at 70° C. for 10 hours as described above. The change amount Δb is obtained by the same method as that for obtaining the change amount Δa described above, except that a sample from which the portion on the back coating layer side on the non-magnetic support is removed is used.

In the present invention and this specification, a thickness of each portion, a thickness of the non-magnetic support, a thickness of each layer, and a total thickness of the magnetic tape can be obtained by a well-known method. For example, a thickness of the magnetic layer is obtained by the following method. After exposing a cross section of the magnetic tape in a thickness direction by a well-known method such as an ion beam or a microtome, an SEM image of the cross section of the exposed cross section is acquired by a scanning electron microscope (SEM). SEM images of cross-sections are acquired for ten randomly extracted locations. A thickness of the magnetic layer is measured at one location randomly extracted from each of the 10 SEM images acquired in this way. In this way, a thickness of the magnetic layer can be obtained as an arithmetic average of ten measurement values obtained for ten images. In a case of obtaining a thickness of the magnetic layer, an interface between the magnetic layer and an adjacent portion (for example, the non-magnetic layer) can be specified by a method disclosed in a paragraph 0029 of JP2017-033617A. Other thicknesses can be obtained in the same manner.

The change amount Δa of tan δ of the portion on the magnetic layer side on the non-magnetic support can be controlled, for example, by a type of components contained in the portion on the magnetic layer side. As an example, in a case where a binding agent is contained in the portion on the magnetic layer side, it can be controlled by a type of the binding agent. By using a binding agent having a high glass transition temperature as the binding agent, a value of Δa tends to decrease. For example, by using a binding agent having a high glass transition temperature as a binding agent of the non-magnetic layer, a value of Δa tends to decrease. The change amount Δb of tan δ of the portion on the back coating layer side can be controlled, for example, by a type of components contained in the portion on the back coating layer side. As an example, in a case where a binding agent is contained in the portion on the back coating layer side, it can be controlled by a type of a binding agent. By using a binding agent having a high glass transition temperature as the binding agent, a value of Δb tends to decrease. In addition, a value of Δb can be controlled by a type of non-magnetic powder contained in the back coating layer. Details of this point will be described later.

Regarding the change amount Δ2, the larger the thickness of the portion on the magnetic layer side occupying the thickness of the various layers provided on both sides on the non-magnetic support is, that is, the larger the value of “Da/(Da+Db)” is, the greater the influence of the change amount Δa of tan δ of the portion on the magnetic layer side on Δ2 is. In addition, the larger the thickness of the portion on the back coating layer side occupying the thickness of the various layers provided on both sides on the non-magnetic support is, that is, the larger the value of “Db/(Da+Db)” is, the greater the influence of the change amount Δb of tan δ of the portion on the back coating layer side on Δ2 is. A value of the change amount Δ2 can be controlled by selecting components constituting the portion on the magnetic layer side and the portion on the back coating layer side in consideration of the thickness of each portion.

Hereinafter, details of each layer of the magnetic tape will be further described.

### Magnetic Layer

### Ferromagnetic Powder

A magnetic layer includes ferromagnetic powder. As the ferromagnetic powder included in the magnetic layer, well-known ferromagnetic powder as ferromagnetic powder used in magnetic layers of various magnetic recording media can be used. It is preferable to use ferromagnetic powder having a small average particle size, from a viewpoint of improvement of recording density. In this respect, an average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from a viewpoint of magnetization stability, an average particle size of the ferromagnetic powder is preferably 5 nm or more, more preferably 8 nm or more, still more preferably 10 nm or more, still more preferably 15 nm or more, and still more preferably 20 nm or more.

### Hexagonal Ferrite Powder

Preferred specific examples of the ferromagnetic powder include hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and this specification, “hexagonal ferrite powder” refers to ferromagnetic powder in which a hexagonal ferrite type crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite type crystal structure in an X-ray diffraction spectrum obtained by X-ray diffraction analysis, it is determined that the hexagonal ferrite type crystal structure is detected as the main phase. In a case where only a single structure is detected by X-ray diffraction analysis, this detected structure is taken as the main phase. The hexagonal ferrite type crystal structure includes at least an iron atom, a divalent metal atom and an oxygen atom, as a constituent atom. The divalent metal atom is a metal atom that can be a divalent cation as an ion, and examples thereof may include an alkaline earth metal atom such as a strontium atom, a barium atom, and a calcium atom, a lead atom, and the like. In the present invention and this specification, hexagonal strontium ferrite powder means that the main divalent metal atom included in this powder is a strontium atom, and hexagonal barium ferrite powder means that the main divalent metal atom included in this powder is a barium atom. The main divalent metal atom refers to a divalent metal atom that accounts for the most on an at % basis among divalent metal atoms included in the powder. Here, a rare earth atom is not included in the above divalent metal atom. The “rare earth atom” in the present invention and this specification is selected from the group consisting of a scandium atom (Sc), an yttrium atom (Y), and a lanthanoid atom. The Lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is an aspect of the hexagonal ferrite powder, will be described in more detail.

An activation volume of hexagonal strontium ferrite powder is preferably in a range of 800 to 1500 nm³. The finely granulated hexagonal strontium ferrite powder having an activation volume in the above range is suitable for producing a magnetic tape exhibiting excellent electromagnetic conversion characteristics. The activation volume of the hexagonal strontium ferrite powder is preferably 800 nm³ or more, for example, 850 nm³ or more. Further, from a viewpoint of further improving the electromagnetic conversion characteristics, the activation volume of the hexagonal strontium ferrite powder is more preferably 1400 nm³ or less, still more preferably 1300 nm³ or less, still more preferably 1200 nm³ or less, and still more preferably 1100 nm³ or less.

The “activation volume” is a unit of magnetization reversal and is an index indicating the magnetic size of a particle. An activation volume described in the present invention and this specification and an anisotropy constant Ku which will be described later are values obtained from the following relational expression between a coercivity Hc and an activation volume V, by performing measurement in an Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

Hc=2Ku/Ms{1−[(kT/KuV)ln(At/0.693)]^{1/2}}

[In the above formula, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, improving thermal stability may include an anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, it means that the higher Ku is, the higher thermal stability is, this is preferable, and thus, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In an aspect, the hexagonal strontium ferrite powder including a rare earth atom may have a rare earth atom surface layer portion uneven distribution property. In the present invention and this specification, the “rare earth atom surface layer portion uneven distribution property” means that a rare earth atom content with respect to 100 at % of an iron atom in a solution obtained by partially dissolving hexagonal strontium ferrite powder with an acid (hereinafter, referred to as a “rare earth atom surface layer portion content” or simply a “surface layer portion content” for a rare earth atom) and a rare earth atom content with respect to 100 at % of an iron atom in a solution obtained by totally dissolving hexagonal strontium ferrite powder with an acid (hereinafter, referred to as a “rare earth atom bulk content” or simply a “bulk content” for a rare earth atom) satisfy a ratio of a rare earth atom surface layer portion content/a rare earth atom bulk content>1.0. A rare earth atom content in hexagonal ferrite powder which will be described later is the same meaning as the rare earth atom bulk content. On the other hand, partial dissolution using an acid dissolves a surface layer portion of a particle configuring hexagonal strontium ferrite powder, and thus, a rare earth atom content in a solution obtained by partial dissolution is a rare earth atom content in a surface layer portion of a particle configuring hexagonal strontium ferrite powder. A rare earth atom surface layer portion content satisfying a ratio of “rare earth atom surface layer portion content/rare earth atom bulk content>1.0” means that in a particle of hexagonal strontium ferrite powder, rare earth atoms are unevenly distributed in a surface layer portion (that is, more than an inside). The surface layer portion in the present invention and this specification means a partial region from a surface of a particle configuring hexagonal strontium ferrite powder toward an inside.

In a case where hexagonal ferrite powder includes a rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle configuring hexagonal strontium ferrite powder contribute to suppression of a decrease in a reproducing output in repeated reproduction. It is supposed that this is because hexagonal strontium ferrite powder includes a rare earth atom with a bulk content in the above range, and rare earth atoms are unevenly distributed in a surface layer portion of a particle configuring hexagonal strontium ferrite powder, and thus it is possible to increase an anisotropy constant Ku. The higher a value of an anisotropy constant Ku is, the more a phenomenon called so-called thermal fluctuation can be suppressed (in other words, thermal stability can be improved). By suppressing occurrence of thermal fluctuation, it is possible to suppress a decrease in reproducing output during repeated reproduction. It is supposed that uneven distribution of rare earth atoms in a particulate surface layer portion of hexagonal strontium ferrite powder contributes to stabilization of spins of iron (Fe) sites in a crystal lattice of a surface layer portion, and thus, an anisotropy constant Ku may be increased.

Moreover, it is supposed that the use of hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that hexagonal strontium ferrite powder having rare earth atom surface layer portion uneven distribution property can also contribute to an improvement of running durability of the magnetic tape. It is supposed that this may be because uneven distribution of rare earth atoms on a surface of a particle configuring hexagonal strontium ferrite powder contributes to an improvement of interaction between the particle surface and an organic substance (for example, a binding agent and/or an additive) included in the magnetic layer, and, as a result, a strength of the magnetic layer is improved.

From a viewpoint of further suppressing a decrease in reproducing output during repeated reproduction and/or a viewpoint of further improving the running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving hexagonal strontium ferrite powder. In the present invention and this specification, unless otherwise noted, the content of an atom means a bulk content obtained by totally dissolving hexagonal strontium ferrite powder. The hexagonal strontium ferrite powder including a rare earth atom may include only one kind of rare earth atom as the rare earth atom, or may include two or more kinds of rare earth atoms. The bulk content in the case of including two or more types of rare earth atoms is obtained for the total of two or more types of rare earth atoms. The same applies to other components in the present invention and this specification. That is, unless otherwise noted, a certain component may be used alone or in combination of two or more. A content amount or content in a case where two or more components are used refers to that for the total of two or more components.

In a case where the hexagonal strontium ferrite powder includes a rare earth atom, the included rare earth atom may be any one or more of rare earth atoms. As a rare earth atom that is preferable from a viewpoint of further suppressing a decrease in reproducing output in repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms may be unevenly distributed in the surface layer portion of a particle configuring the hexagonal strontium ferrite powder, and the degree of uneven distribution is not limited. For example, for a hexagonal strontium ferrite powder having a rare earth atom surface layer portion uneven distribution property, a ratio between a surface layer portion content of a rare earth atom obtained by partial dissolution under dissolution conditions which will be described later and a bulk content of a rare earth atom obtained by total dissolution under dissolution conditions which will be described later, that is, “surface layer portion content/bulk content” exceeds 1.0 and may be 1.5 or more. A “surface layer portion content/bulk content” larger than 1.0 means that in a particle configuring the hexagonal strontium ferrite powder, rare earth atoms are unevenly distributed in the surface layer portion (that is, more than in the inside). Further, a ratio between a surface layer portion content of a rare earth atom obtained by partial dissolution under dissolution conditions which will be described later and a bulk content of a rare earth atom obtained by total dissolution under the dissolution conditions which will be described later, that is, “surface layer portion content/bulk content” may be, for example, 10.0 or less, 9.0 or less, 8.0 or less, 7.0 or less, 6.0 or less, 5.0 or less, or 4.0 or less. Here, in the hexagonal strontium ferrite powder having a rare earth atom surface layer portion uneven distribution property, the rare earth atoms may be unevenly distributed in the surface layer portion of a particle configuring the hexagonal strontium ferrite powder, and the “surface layer portion content/bulk content” is not limited to the illustrated upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method disclosed in a paragraph 0032 of JP2015-091747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle configuring the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Here, the following dissolution conditions such as an amount of sample powder are illustrative, and dissolution conditions for partial dissolution and total dissolution can be employed in any manner.

A container (for example, a beaker) containing 12 mg of sample powder and 10 ml of 1 mol/L hydrochloric acid is held on a hot plate at a set temperature of 70° C. for 1 hour. The obtained solution is filtered by a membrane filter of 0.1 μm. Elemental analysis of the filtrated solution is performed by an inductively coupled plasma (ICP) analyzer. In this way, the surface layer portion content of a rare earth atom with respect to 100 at % of an iron atom can be obtained. In a case where a plurality of types of rare earth atoms are detected by elemental analysis, the total content of all rare earth atoms is defined as the surface layer portion content. The same applies to the measurement of the bulk content.

On the other hand, the total dissolution and measurement of the bulk content are performed by the following method, for example.

A container (for example, a beaker) containing 12 mg of sample powder and 10 ml of 4 mol/L hydrochloric acid is held on a hot plate at a set temperature of 80° C. for 3 hours. Thereafter, the method is carried out in the same manner as the partial dissolution and the measurement of the surface layer portion content, and the bulk content with respect to 100 at % of an iron atom can be obtained.

From a viewpoint of increasing the reproducing output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have σs largely lower than the hexagonal strontium ferrite powder including no rare earth atom. On the other hand, it is considered that hexagonal strontium ferrite powder having a rare earth atom surface layer portion uneven distribution property is preferable in suppressing such a large decrease in σs. In an aspect, σs of the hexagonal strontium ferrite powder may be 45 A·m²/kg or more, and may be 47 A·m²/kg or more. On the other hand, from a viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and this specification, unless otherwise noted, the mass magnetization σs is a value measured at a magnetic field intensity of 1194 KA/m (15 kOe).

Regarding the content (bulk content) of a constituent atom of the hexagonal ferrite powder, a strontium atom content may be, for example, in a range of 2.0 to 15.0 at % with respect to 100 at % of an iron atom. In an aspect, in the hexagonal strontium ferrite powder, a divalent metal atom included in the powder may be only a strontium atom. In another aspect, the hexagonal strontium ferrite powder may include one or more other divalent metal atoms in addition to a strontium atom. For example, a barium atom and/or a calcium atom may be included. In a case where another divalent metal atom other than a strontium atom is included, a barium atom content and a calcium atom content in the hexagonal strontium ferrite powder are, for example, in a range of 0.05 to 5.0 at % with respect to 100 at % of an iron atom, respectively.

As a crystal structure of hexagonal ferrite, a magnetoplumbite type (also called an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to an aspect, in the hexagonal strontium ferrite powder, only the M-type crystal structure may be detected by X-ray diffraction analysis. For example, M-type hexagonal ferrite is represented by a composition formula of AFe₁₂O₁₉. Here, A represents a divalent metal atom, and in a case where the hexagonal strontium ferrite powder is the M-type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom can be, for example, 0.5 to 10.0 at % with respect to 100 at % of an iron atom. From a viewpoint of further suppressing a decrease in reproducing output in repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in an aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving hexagonal strontium ferrite powder into a value expressed in at % using an atomic weight of each atom. Further, in the present invention and this specification, “not include” for a certain atom means that a content measured by an ICP analyzer after total dissolution is 0 mass %. A detection limit of the ICP analyzer is usually 0.01 parts per million (ppm) or less on a mass basis. The “not included” is used as a meaning including that an atom is included in an amount less than the detection limit of the ICP analyzer. In an aspect, the hexagonal strontium ferrite powder may not include a bismuth atom (Bi).

### Metal Powder

Preferred specific examples of the ferromagnetic powder include ferromagnetic metal powder. For details of the ferromagnetic metal powder, for example, descriptions disclosed in paragraphs 0137 to 0141 of JP2011-216149A and paragraphs 0009 to 0023 of JP2005-251351A can be referred to.

### ε-Iron Oxide Powder

Preferred specific examples of the ferromagnetic powder include ε-iron oxide powder. In the present invention and this specification, “ε-iron oxide powder” refers to ferromagnetic powder in which a ε-iron oxide type crystal structure is detected as a main phase by X-ray diffraction analysis. For example, in a case where the highest intensity diffraction peak is attributed to a ε-iron oxide type crystal structure in an X-ray diffraction spectrum obtained by X-ray diffraction analysis, it is determined that the ε-iron oxide type crystal structure is detected as the main phase. As a manufacturing method of the ε-iron oxide powder, a manufacturing method from a goethite, a reverse micelle method, and the like are known. All of the manufacturing methods are well known. Regarding a method of manufacturing ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Here, the manufacturing method of ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for producing a magnetic tape exhibiting excellent electromagnetic conversion characteristics. The activation volume of the ε-iron oxide powder is preferably 300 nm³ or more, for example, 500 nm³ or more. Further, from a viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, improving thermal stability may include an anisotropy constant Ku. The ε-iron oxide powder preferably has Ku of 3.0×10⁴ J/m³ or more, and more preferably has Ku of 8.0×10⁴ J/m³ or more. Ku of the ε-iron oxide powder may be, for example, 3.0×10⁵ J/m³ or less. Here, it means that the higher Ku is, the higher thermal stability is, this is preferable, and thus, a value thereof is not limited to the values exemplified above.

From a viewpoint of increasing the reproducing output in a case of reproducing data recorded on the magnetic tape, it is desirable that mass magnetization σs of the ferromagnetic powder included in the magnetic tape is high. In this regard, in an aspect, σs of the ε-iron oxide powder may be 8 A·m²/kg or more, and may be 12 A·m²/kg or more. On the other hand, from a viewpoint of noise reduction, σs of the ε-iron oxide powder is preferably 40 A·m²/kg or less and more preferably 35 A·m²/kg or less.

In the present invention and this specification, unless otherwise noted, an average particle size of various types of powder such as ferromagnetic powder is a value measured by the following method using a transmission electron microscope.

The powder is imaged at a magnification ratio of 100,000 with a transmission electron microscope, and the image is printed on printing paper, is displayed on a display, or the like so that the total magnification ratio is 500,000 to obtain an image of particles configuring the powder. A target particle is selected from the obtained image of particles, an outline of the particle is traced with a digitizer, and a size of the particle (primary particle) is measured. The primary particle is an independent particle which is not aggregated.

The measurement described above is performed regarding 500 particles randomly extracted. An arithmetic average of the particle sizes of 500 particles obtained as described above is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in examples which will be described later is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and this specification, the powder means an aggregate of a plurality of particles. For example, ferromagnetic powder means an aggregate of a plurality of ferromagnetic particles. Further, the aggregate of the plurality of particles not only includes an aspect in which particles configuring the aggregate directly come into contact with each other, but also includes an aspect in which a binding agent or an additive which will be described later is interposed between the particles. The term “particle” is used to describe a powder in some cases.

As a method of taking sample powder from the magnetic tape in order to measure the particle size, a method disclosed in a paragraph of 0015 of JP2011-048878A can be used, for example.

In the present invention and this specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an unspecified shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %. A high filling percentage of the ferromagnetic powder in the magnetic layer is preferable from a viewpoint of improvement of recording density.

### Binding Agent

The above-described magnetic tape may be a coating type magnetic tape, and may include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described later. As described above, in an aspect, Δa and Δb can be adjusted by the binding agent.

For the binding agent described above, descriptions disclosed in paragraphs 0028 to 0031 of JP2010-024113A and paragraphs 0006 to 0021 of JP2004-005795A can be referred to. An average molecular weight of the resin used as the binding agent can be, for example, 10,000 or more and 200,000 or less as a weight-average molecular weight. The average molecular weight of the present invention and this specification is a value obtained by performing polystyrene conversion of a value measured by gel permeation chromatography (GPC) under the following measurement conditions. The average molecular weight shown in examples of a binding agent which will be described later is a value obtained by performing polystyrene conversion of a value measured under the following measurement conditions. The binding agent can be used in an amount of, for example, 1.0 to 80.0 parts by mass with respect to 100.0 parts by mass of the ferromagnetic powder. For the amount of the binding agent in the non-magnetic layer and the back coating layer, the description regarding the amount of the binding agent in the magnetic layer can be applied by replacing the ferromagnetic powder with the non-magnetic powder.

GPC device: HLC-8120 (manufactured by Tosoh Corporation)

Column: TSK gel Multipore HXL-M (manufactured by Tosoh Corporation, 7.8 mm inner diameter (ID)×30.0 cm)

Eluent: Tetrahydrofuran (THF)

A curing agent can also be used together with the resin which can be used as the binding agent. As the curing agent, in an aspect, a thermosetting compound which is a compound in which a curing reaction (crosslinking reaction) is progressed due to heating can be used, and in another aspect, a photocurable compound in which a curing reaction (crosslinking reaction) is progressed due to light irradiation can be used. Curing reaction proceeds in a magnetic layer forming process, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The content of the curing agent in a magnetic layer forming composition can be, for example, 0 to 80.0 parts by mass, and from a viewpoint of improving a strength of the magnetic layer, can be 50.0 to 80.0 parts by mass, with respect to 100.0 parts by mass of the binding agent. The same applies to non-magnetic layer forming composition and back coating layer forming composition.

### Additive

The magnetic layer may include one or more kinds of additives, as necessary. As the additives, the curing agent described above is used as an example. In addition, examples of the additive which can be included in the magnetic layer include non-magnetic powder (for example, inorganic powder or carbon black), a lubricant, a dispersing agent, a dispersing assistant, an antibacterial agent, an antistatic agent, an antioxidant, and the like. For example, for the lubricant, descriptions disclosed in paragraphs 0030 to 0033, 0035, and 0036 of JP2016-126817A can be referred to. The non-magnetic layer described later may include a lubricant. For the lubricant which may be included in the non-magnetic layer, descriptions disclosed in paragraphs 0030, 0031, 0034, 0035, and 0036 of JP2016-126817A can be referred to. For the dispersing agent, descriptions disclosed in paragraphs 0061 and 0071 of JP2012-133837A can be referred to. For the additive of the magnetic layer, descriptions disclosed in paragraphs 0035 to 0077 of JP2016-051493A can be referred to. A dispersing agent may be added to the non-magnetic layer forming composition. For the dispersing agent which can be included in the non-magnetic layer forming composition, a description disclosed in paragraph 0061 of JP2012-133837A can be referred to. As the non-magnetic powder that can be included in the magnetic layer, non-magnetic powder which can function as an abrasive, or non-magnetic powder which can function as a protrusion forming agent which forms protrusions suitably protruded from the magnetic layer surface (for example, non-magnetic colloidal particles) is used. An average particle size of colloidal silica (silica colloidal particle) shown in the examples described later is a value obtained by a method disclosed in a paragraph 0015 of JP2011-048878A as a method for measuring an average particle size. As the additive, a commercially available product can be suitably selected or manufactured by a well-known method according to the desired properties, and any amount thereof can be used. Examples of the additive that can be used to improve the dispersibility of the abrasive in the magnetic layer containing the abrasive include a dispersing agent disclosed in paragraphs 0012 to 0022 of JP2013-131285A.

The magnetic layer described above can be provided directly on a surface of the non-magnetic support or indirectly through the non-magnetic layer.

### Non-Magnetic Layer

Next, the non-magnetic layer will be described. The above magnetic tape may have a magnetic layer directly on the surface of the non-magnetic support, or may have a magnetic layer on the surface of the non-magnetic support via a non-magnetic layer including non-magnetic powder. Non-magnetic powder used for the non-magnetic layer may be an inorganic powder or an organic powder. In addition, carbon black and the like can be used. Examples of the inorganic powder include powder such as metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-024113A can be referred to. The content (filling percentage) of the non-magnetic powder of the non-magnetic layer is preferably in a range of 50 to 90 mass % and more preferably in a range of 60 to 90 mass %.

In regards to other details of a binding agent or an additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

In the present invention and this specification, the non-magnetic layer also includes a substantially non-magnetic layer including a small amount of ferromagnetic powder as impurities, for example, or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and a coercivity.

### Back Coating Layer

The magnetic tape may or may not have a back coating layer including non-magnetic powder on a surface side of the non-magnetic support opposite to a surface side having the magnetic layer. Preferably, the back coating layer contains one or both of carbon black and inorganic powder. As the carbon black, for example, carbon black having an average particle size of 17 nm or more and 50 nm or less (hereinafter, referred to as “fine particle carbon black”.) can be used, and carbon black having an average particle size of more than 50 nm and 300 nm or less (hereinafter, referred to as “coarse particle carbon black”.) can be used. Further, fine particle carbon black and coarse particle carbon black can be used in combination.

Examples of the inorganic powder include non-magnetic powder generally used for the non-magnetic layer, non-magnetic powder generally used as an abrasive for the magnetic layer, and the like. Among these, α-iron oxide, α-alumina, or the like is preferable. The average particle size of the inorganic powder in the back coating layer can be, for example, in a range of 5 to 250 nm. In a case where the carbon black and the inorganic powder are used in combination as the non-magnetic powder of the back coating layer, the higher the percentage of the inorganic powder to the total amount of the non-magnetic powder is, the smaller the value of the change amount Δb of tan δ of the portion on the back coating layer side on the non-magnetic support tends to be. In an aspect, the inorganic powder is preferably contained in an amount of more than 50.0 parts by mass, and more preferably 70.0 to 90.0 parts by mass, with respect to the total amount of the non-magnetic powder of 100.0 parts by mass. In an aspect, the description regarding the non-magnetic powder of the back coating layer can be applied to the non-magnetic powder of the non-magnetic layer.

The back coating layer can include a binding agent, and can also include an additive, as necessary. In regards to the binding agent and the additive of the back coating layer, the well-known technology regarding the back coating layer can be applied, and the well-known technology regarding the treatment of the magnetic layer and/or the non-magnetic layer can be applied. For example, for the back coating layer, descriptions disclosed in paragraphs 0018 to 0020 of JP2006-331625A and page 4, line 65 to page 5, line 38 of U.S. Pat. No. 7,029,774B can be referred to.

### Non-Magnetic Support

The magnetic tape has at least a non-magnetic support and a magnetic layer. As the non-magnetic support (hereinafter, also simply referred to as a “support”.), a polyethylene naphthalate support, a polyamide support, a polyethylene terephthalate support, a polyamideimide support, and the like are used. These supports can be purchased as a commercially available product or can be manufactured by a well-known method. As the support, a polyethylene naphthalate support, a polyamide support, and a polyethylene terephthalate support are preferable from a viewpoint of a strength, a flexibility, or the like. The polyethylene naphthalate support means a support including at least a polyethylene naphthalate layer, and includes a support consisting of a single or two or more polyethylene naphthalate layers and a support including one or more other layers in addition to the polyethylene naphthalate layer. The same applies to other supports. In addition, polyamide can include an aromatic skeleton and/or an aliphatic skeleton, and polyamide including an aromatic skeleton (aromatic polyamide) is preferable, and aramid is more preferable. A corona discharge, a plasma treatment, an easy-bonding treatment, or a thermal treatment may be performed with respect to the support in advance.

### Various Thicknesses

A thickness of the non-magnetic support is, for example, 3.00 to 80.00 μm, preferably 3.00 to 20.00 μm, and more preferably 3.00 to 10.00 μm.

A thickness of the magnetic layer can be optimized according to a saturation magnetization amount, a head gap length, and a band of a recording signal of the used magnetic head, and is generally 0.01 μm to 0.15 μm, and from a viewpoint of high density recording, is preferably 0.02 μm to 0.12 μm, and more preferably 0.03 μm to 0.10 μm. The magnetic layer may be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

The thickness Db of the portion on the back coating layer side on the non-magnetic support can be the thickness of the back coating layer. In an aspect, the thickness of the back coating layer is preferably 0.90 μm or less, and more preferably 0.70 μm or less, and alternatively, preferably 0.10 μm or more, and more preferably 0.20 μm or more. In this case, the thickness Da of the portion on the magnetic layer side on the non-magnetic support is preferably 0.15 μm or more, and more preferably 0.20 μm or more, and alternatively, preferably 1.00 μm or less, and more preferably 0.70 μm or less. Here, the thickness of the non-magnetic layer is preferably 0.08 μm or more, and more preferably 0.13 μm or more, and alternatively, preferably 0.93 μm or less, and more preferably 0.63 μm or less.

In another aspect, the thickness of the back coating layer is preferably 1.80 μm or less, and more preferably 1.50 μm or less, and alternatively, preferably 0.15 μm or more, and more preferably 0.20 μm or more, and may be more than 0.90 μm and may be 1.00 μm or more. In this case, the thickness Da of the portion on the magnetic layer side on the non-magnetic support is preferably 0.15 μm or more, and more preferably 0.20 μm or more, and alternatively, preferably 0.50 μm or less, and more preferably 0.40 μm or less. Here, the thickness of the non-magnetic layer is preferably 0.08 μm or more, and more preferably 0.13 μm or more, and alternatively, preferably 0.42 μm or less, and more preferably 0.33 μm or less.

### Manufacturing Process

### Preparation of Each Layer Forming Composition

A process of preparing a composition for forming a magnetic layer, a non-magnetic layer, or a back coating layer can usually include at least a kneading process, a dispersing process, and a mixing process provided before and after these processes as necessary. Each process may be divided into two or more stages. Components used for the preparation of each layer forming composition may be added at an initial stage or in a middle stage of each process. As a solvent, one kind or two or more kinds of various solvents generally used for manufacturing a coating type magnetic recording medium can be used. For the solvent, for example, a description disclosed in a paragraph 0153 of JP2011-216149A can be referred to. In addition, each component may be separately added in two or more processes. For example, a binding agent may be added separately in a kneading process, a dispersing process, and a mixing process for adjusting a viscosity after dispersion. In order to manufacture the magnetic tape, a well-known manufacturing technology can be used in various processes. In the kneading process, preferably, a kneader having a strong kneading force such as an open kneader, a continuous kneader, a pressure kneader, or an extruder is used. For details of the kneading treatment, descriptions disclosed in JP1989-106338A (JP-H01-106338A) and JP1989-079274A (JP-H01-079274A) can be referred to. As a dispersing device, a well-known dispersing device can be used. In any stage of preparing each layer forming composition, filtering may be performed by a well-known method. The filtering can be performed by using a filter, for example. As the filter used in the filtering, a filter having a pore diameter of 0.01 to 3 μm (for example, filter made of glass fiber or filter made of polypropylene) can be used, for example.

### Coating Process

The magnetic layer can be formed by directly applying the magnetic layer forming composition onto the surface of the non-magnetic support or performing multilayer applying of the magnetic layer forming composition with the non-magnetic layer forming composition in order or at the same time. The back coating layer can be formed by applying the back coating layer forming composition onto a surface of the non-magnetic support opposite to a surface having the non-magnetic layer and/or the magnetic layer (or to be provided with the non-magnetic layer and/or the magnetic layer). For details of application for forming each layer, a description disclosed in a paragraph 0066 of JP2010-231843A can be referred to.

### Other Processes

Well-known technologies can be applied to other various processes for manufacturing the magnetic tape. For the various processes, for example, descriptions disclosed in paragraphs 0067 to 0070 of JP2010-231843A can be referred to. For example, a coating layer of the magnetic layer forming composition can be subjected to an orientation treatment while the coating layer is in a wet (undried) state. For the orientation treatment, the various well-known technologies such as descriptions disclosed in a paragraph 0052 of JP2010-024113A can be used. For example, a vertical orientation treatment can be performed by a well-known method such as a method using a polar opposing magnet. In an orientation zone, a drying speed of the coating layer can be controlled depending on a temperature and a flow rate of dry air and/or a transportation speed in the orientation zone. Further, the coating layer may be preliminarily dried before the transportation to the orientation zone.

Through various processes, a long magnetic tape original roll can be obtained. The obtained magnetic tape original roll is cut (slit) by a well-known cutter to have a width of the magnetic tape to be wound around the magnetic tape cartridge. The width is determined according to the standard, and is typically ½ inches. 1 inch=0.0254 meters.

It is possible to form a servo pattern in the manufactured magnetic tape by a well-known method in order to enable tracking control of the magnetic head in the magnetic recording and reproducing apparatus, control of a running speed of the magnetic tape, and the like. The “formation of servo pattern” can also be referred to as “recording of servo signal”. Hereinafter, the formation of the servo pattern will be described.

The servo pattern is usually formed along a longitudinal direction of the magnetic tape. Examples of control (servo control) types using a servo signal include a timing-based servo (TBS), an amplitude servo, and a frequency servo.

As shown in a european computer manufacturers association (ECMA)-319, a magnetic tape (generally called “LTO tape”) conforming to a linear tape-open (LTO) standard employs a timing-based servo type. In this timing-based servo type, the servo pattern is formed by continuously disposing a plurality of pairs of non-parallel magnetic stripes (also referred to as “servo stripes”) in a longitudinal direction of the magnetic tape. In the present invention and this specification, a “timing-based servo pattern” refers to a servo pattern that enables head tracking in a timing-based servo system servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed so that an interval thereof continuously changes along a width direction of the magnetic tape, and the servo signal reading element reads the interval to thereby sense a relative position between the servo pattern and the servo signal reading element. Information on this relative position enables tracking on a data track. Therefore, a plurality of servo tracks are usually set on the servo pattern along a width direction of the magnetic tape.

A servo band is formed of servo signals continuous in a longitudinal direction of the magnetic tape. A plurality of servo bands are usually provided on the magnetic tape. For example, in an LTO tape, the number is five. A region interposed between two adjacent servo bands is referred to as a data band. The data band is formed of a plurality of data tracks, and each data track corresponds to each servo track.

Further, in an aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in a longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

Incidentally, as a method for uniquely specifying the servo band, there is a method using a staggered method as shown in ECMA-319. In this staggered method, a group of pairs of non-parallel magnetic stripes (servo stripes) disposed continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319, information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Here, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) process. This erasing process can be performed by applying a uniform magnetic field to the magnetic tape using a direct current magnet or an alternating current magnet. The erasing process includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two methods. A first method is horizontal DC erasing of applying a magnetic field in one direction along a longitudinal direction of the magnetic tape. A second method is vertical DC erasing of applying a magnetic field in one direction along a thickness direction of the magnetic tape. The erasing process may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-053940A, in a case where a magnetic pattern is transferred to, using the gap, a magnetic tape that has been subjected to vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

The magnetic tape is usually accommodated in a magnetic tape cartridge and the magnetic tape cartridge is mounted in the magnetic recording and reproducing apparatus.

### Magnetic Tape Cartridge

Another aspect of the present invention relates to a magnetic tape cartridge including the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing apparatus for recording and/or reproducing data on the magnetic tape, the magnetic tape is pulled out of the magnetic tape cartridge to be wound around the reel on the magnetic recording and reproducing apparatus side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing apparatus side. During this time, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge. The magnetic tape cartridge may be either a single reel type or a dual reel type magnetic tape cartridge. The above magnetic tape cartridge has only to include the magnetic tape according to an embodiment of the present invention, and the well-known technology can be applied to the others.

### Magnetic Recording and Reproducing Apparatus

Another aspect of the present invention relates to a magnetic recording and reproducing apparatus including the magnetic tape described above and a magnetic head.

In the present invention and this specification, the “magnetic recording and reproducing apparatus” means an apparatus capable of performing at least one of the recording of data on the magnetic tape or the reproducing of data recorded on the magnetic tape. Such an apparatus is generally called a drive. The magnetic recording and reproducing apparatus can be a sliding type magnetic recording and reproducing apparatus. The sliding type magnetic recording and reproducing apparatus is an apparatus in which the magnetic layer surface and the magnetic head come into contact with each other to be slid on each other, in a case of performing the recording of data on the magnetic tape and/or reproducing of the recorded data.

The magnetic head included in the magnetic recording and reproducing apparatus can be a recording head capable of performing the recording of data on the magnetic tape, or can be a reproducing head capable of performing the reproducing of data recorded on the magnetic tape. In addition, in an aspect, the magnetic recording and reproducing apparatus can include both of a recording head and a reproducing head as separate magnetic heads. In another aspect, the magnetic head included in the magnetic recording and reproducing apparatus can have a configuration that both of an element for recording data (recording element) and an element for reproducing data (reproducing element) are included in one magnetic head. Hereinafter, the element for recording and the element for reproducing data are collectively referred to as an “element for data”. As the reproducing head, a magnetic head (MR head) including a magnetoresistive (MR) element capable of sensitively reading data recorded on the magnetic tape as a reproducing element is preferable. As the MR head, various known MR heads such as an anisotropic magnetoresistive (AMR) head, a giant magnetoresistive (GMR) head, and a tunnel magnetoresistive (TMR) head can be used. In addition, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic recording and reproducing apparatus. For example, a magnetic head that records data and/or reproduces recorded data (hereinafter also referred to as “recording and reproducing head”) can include two servo signal reading elements, and the two servo signal reading elements can read two adjacent servo bands simultaneously. One or a plurality of elements for data can be disposed between the two servo signal reading elements.

In the magnetic recording and reproducing apparatus, recording of data on the magnetic tape and/or reproducing of data recorded on the magnetic tape can be performed as the magnetic layer surface of the magnetic tape and the magnetic head come into contact with each other to be slid on each other. The magnetic recording and reproducing apparatus has only to include the magnetic tape according to an embodiment of the present invention, and the well-known technology can be applied to the others.

For example, in a case of recording data and/or reproducing the recorded data, first, tracking using a servo signal is performed. That is, by causing the servo signal reading element to follow a predetermined servo track, the element for data is controlled to pass on the target data track. Displacement of the data track is performed by changing a servo track to be read by the servo signal reading element in a tape width direction.

The recording and reproducing head can also perform recording and/or reproducing with respect to other data bands. In this case, the servo signal reading element may be displaced to a predetermined servo band using the above described UDIM information, and tracking for the servo band may be started.

### EXAMPLES

Hereinafter, the present invention will be described with reference to examples. Here, the present invention is not limited to aspects shown in the examples. “Parts” and “%” in the following description mean “parts by mass” and “mass %”, unless otherwise noted. The following processes and evaluation were performed in an air of 23° C.±1° C., unless otherwise specified.

### Example 1

List of each layer forming composition is shown below.

### List of Magnetic Layer Forming Composition

### Magnetic Liquid

Ferromagnetic powder (type: see below): 100.0 parts

Oleic acid: 2.0 parts

Vinyl chloride copolymer (MR-104 manufactured by Kaneka Corporation): 10.0 parts
(weight-average molecular weight: 55,000, active hydrogen-containing group (hydroxy group): 0.33 meq/g, OSO₃K group (potassium salt of sulfuric acid group): 0.09 meq/g)

SO₃Na group-containing polyurethane resin: 4.0 parts
(weight-average molecular weight: 70,000, active hydrogen-containing group (hydroxy group): 4 to 6 mgKOH/g, SO₃Na group (sodium salt of sulfonic acid group): 0.07 meq/g)

Polyalkyleneimine polymer (synthetic product obtained by the method disclosed in paragraphs 0115 to 0123 of JP2016-051493A): 6.0 parts

Methyl ethyl ketone: 150.0 parts

Cyclohexanone: 150.0 parts

### Abrasive Liquid

α-alumina (Brunauer-emmett-teller (BET) specific surface area: 19 m²/g): 6.0 parts

SO₃Na group-containing polyurethane resin: 0.6 parts
(weight-average molecular weight: 70,000, SO₃Na group: 0.1 meq/g)

2,3-dihydroxynaphthalene: 0.6 parts

Cyclohexanone: 23.0 parts

### Protrusion Forming Agent Liquid

Colloidal silica (average particle size: 120 nm): 2.0 parts

Methyl ethyl ketone: 8.0 parts

### Other Components

Stearic acid: 3.0 parts

Stearic acid amide: 0.3 parts

Butyl stearate: 6.0 parts

Methyl ethyl ketone: 110.0 parts

Cyclohexanone: 110.0 parts

Polyisocyanate (CORONATE (registered trademark) L manufactured by Tosoh Corporation): 3.0 parts

### List of Non-Magnetic Layer Forming Composition and Back Coating Layer Forming Composition

Polyurethane 1: See Table 1

Polyurethane 2: See Table 1

α-iron oxide (DPN-550RXN manufactured by Toda Kogyo Co., Ltd.): 1,000 parts
αFe₂O₃ Hematite (Bengala)
Average particle size: 200 nm
Long axis length: 0.15 μm
BET specific surface area: 52 m²/g
pH: 6
Tap density: 0.8
Dibutyl phthalate (DBP) oil absorption: 27 to 38 g/100 g
Surface treatment agent: Al₂O₃, SiO₂

Carbon black (#950 manufactured by Mitsubishi Chemical Corporation): 333 parts
Average particle size: 18 nm
BET specific surface area: 260 m²/g
DBP oil absorption: 79 ml/100 g (powder)
pH: 7.5

Phenylphosphonic acid: 40 parts

Polyisocyanate (CORONATE L manufactured by Tosoh Corporation): 25 parts

Butyl stearate: 8 parts

Stearic acid: 20 parts

Methyl ethyl ketone/cyclohexanone (8/2 (mass ratio) mixed solvent): 250 parts

### Preparation of Magnetic Layer Forming Composition

A magnetic layer forming composition was prepared by the following method.

Various components of the magnetic liquid were dispersed (bead dispersion) for 24 hours using a batch type vertical sand mill to prepare a magnetic liquid. As dispersed beads, zirconia beads having a bead diameter of 0.5 mm were used.

Various components of the above abrasive liquid were mixed and then the mixture was put in a horizontal beads mill dispersing device together with zirconia beads having a bead diameter of 0.3 mm, and the bead volume/(abrasive liquid volume+bead volume) was adjusted to be 80%, and a beads mill dispersion process was performed for 120 minutes. The liquid after the process was taken out and subjected to ultrasonic dispersion filtration process using a flow type ultrasonic dispersion filtration device. Thereby, an abrasive liquid was prepared.

The prepared magnetic liquid and abrasive liquid, and the protrusion forming agent liquid and other components were put into a dissolver or a stirrer and stirred for 30 minutes at a circumferential speed of 10 m/sec, and subjected to processes of 3 passes at a flow rate of 7.5 kg/min by a flow type ultrasonic dispersing device, and then a magnetic layer forming composition was prepared by filtration through a filter having a pore diameter of 1 μm.

### Preparation of Non-Magnetic Layer Forming Composition and Back Coating Layer Forming Composition

A non-magnetic layer forming composition and a back coating layer forming composition were the same composition having the above-described list, and were prepared by the following method and used.

A composition obtained by dispersing various components of the composition using zirconia beads having a bead diameter of 0.1 mm by a batch type vertical sand mill for 24 hours, and then filtering the components using a filter having an average pore diameter of 0.5 μm was used as a non-magnetic layer forming composition and a back coating layer forming composition.

The non-magnetic layer forming composition prepared in the above section was applied onto a surface of a biaxially stretched aromatic polyamide support having a thickness of 5.00 μm and was dried so that a thickness after drying is a thickness shown in Table 1, and thus a non-magnetic layer was formed. After that, the magnetic layer forming composition prepared in the above section was applied onto a surface of the non-magnetic layer so that a thickness after drying is 0.07 μm, and thus a coating layer was formed. While this coating layer of the magnetic layer forming composition is in a wet (undried) state, a vertical orientation treatment was performed in which a magnetic field of a magnetic field intensity of 0.3 T was applied in a direction perpendicular to a surface of the coating layer, and then the surface of the coating layer was dried. Thereafter, the back coating layer forming composition prepared in the above section was applied onto an opposite surface of the support so that the thickness after drying is a thickness shown in Table 1, and then was dried. Thereby, a magnetic tape original roll was manufactured.

Thereafter, a surface smoothing treatment (calendering treatment) was performed once using a calender formed of only metal rolls at a speed of 100 m/min, a linear pressure of 294 kN/m, and a surface temperature of a calender roll of 90° C., and then a heat treatment was performed in an environment of an atmosphere temperature of 70° C. for 36 hours. After the heat treatment, the resultant was slit to have ½ inches width to obtain a magnetic tape. 1 inch=0.0254 meters.

Thus, a magnetic tape of Example 1 was obtained.

### Examples 2 to 27 and Comparative Examples 1 to 4

Each magnetic tape of Examples 2 to 27 and Comparative Examples 1 to 4 was manufactured in the same manner as in Example 1 except that various items were changed as shown in Table 1.

In Table 1, “BaFe” represents hexagonal barium ferrite powder having an average particle size (average plate diameter) of 21 nm. “SrFe1” and “SrFe2” represent hexagonal strontium ferrite powder, and “ε-iron oxide” represents ε-iron oxide powder.

An activation volume and an anisotropy constant Ku of various types of ferromagnetic powder described below are values obtained by the method described above using a vibrating sample magnetometer (manufactured by Toei Kogyo Co., Ltd.) for each ferromagnetic powder.

A mass magnetization σs is a value measured at a magnetic field intensity of 15 kOe using a vibrating sample magnetometer (manufactured by Toei Industry Co., Ltd.).

### Method for manufacturing Ferromagnetic Powder

### Manufacturing Method 1 of Hexagonal Strontium Ferrite Powder

“SrFe1” shown in Table 1 is hexagonal strontium ferrite powder manufactured by the following method.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a water-cooled twin roller to manufacture an amorphous body.

280 g of the manufactured amorphous body was charged into an electric furnace, was heated to 635° C. (crystallization temperature) at a heating rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically allowed to stand at a liquid temperature of 100° C. for 3 hours and subjected to a dissolving process of a glass component, and then the crystallized product was sedimented by a centrifugal separator to be washed by repeatedly performing decantation and was dried in a heating furnace at an internal temperature of the furnace of 110° C. for 6 hours to obtain hexagonal strontium ferrite powder.

The hexagonal strontium ferrite powder (“SrFe1” in Table 1) obtained above had an average particle size of 18 nm, an activation volume of 902 nm³, an anisotropy constant Ku of 2.2×10⁵ J/m³, and a mass magnetization as of 49 A. m²/kg.

12 mg of sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was checked that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was checked by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

PANalytical X'Pert Pro diffractometer, PIXcel detector

Soller slit of incident beam and diffracted beam: 0.017 radians

Fixed angle of dispersion slit: ¼ degrees

Mask: 10 mm

Anti-scattering slit: ¼ degrees

Measurement mode: continuous

Measurement time per stage: 3 seconds

Measurement speed: 0.017 degrees per second

Measurement step: 0.05 degrees

### Manufacturing Method 2 of Hexagonal Strontium Ferrite Powder

“SrFe2” shown in Table 1 is hexagonal strontium ferrite powder manufactured by the following method.

1725 g of SrCO₃, 666 g of H₃BO₃, 1332 g of Fe₂O₃, 52 g of Al(OH)₃, 34 g of CaCO₃, and 141 g of BaCO₃ were weighed and mixed by a mixer to obtain a raw material mixture.

The obtained raw material mixture was dissolved in a platinum crucible at a melting temperature of 1380° C., and a hot water outlet provided at a bottom of the platinum crucible was heated while stirring a melt, and the melt was discharged in a rod shape at about 6 g/sec. Hot water was rolled and quenched by a water-cooled twin roller to manufacture an amorphous body.

280 g of the obtained amorphous body was charged into an electric furnace, was heated to 645° C. (crystallization temperature), and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically allowed to stand at a liquid temperature of 100° C. for 3 hours and subjected to a dissolving process of a glass component, and then the crystallized product was sedimented by a centrifugal separator to be washed by repeatedly performing decantation and was dried in a heating furnace at an internal temperature of the furnace of 110° C. for 6 hours to obtain hexagonal strontium ferrite powder.

The obtained hexagonal strontium ferrite powder (“SrFe2” in Table 1) had an average particle size of 19 nm, an activation volume of 1102 nm³, an anisotropy constant Ku of 2.0×10⁵ J/m³, and a mass magnetization σs of 50 A·m²/kg.

### Method of Manufacturing ε-Iron Oxide Powder

“ε-iron oxide” shown in Table 1 is ε-iron oxide powder manufactured by the following method.

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid aqueous solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at a furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. Powder sedimented by adding 50 g of ammonium sulfate to the obtained reaction solution was collected by centrifugal separation, was washed with pure water, and was dried in a heating furnace at a furnace temperature of 80° C. for 24 hours to obtain a ferromagnetic powder precursor.

The obtained ferromagnetic powder precursor was loaded into a heating furnace at a furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ε-iron oxide (ε-Gao_{0.28}Co_{0.05}Ti_{0.05}Fe_{1.62}O₃). In addition, X-ray diffraction analysis is performed under the same condition as that described above for the manufacturing method 1 of hexagonal strontium ferrite powder, and from a peak of an X-ray diffraction pattern, it is checked that the obtained ferromagnetic powder does not include α-phase and γ-phase crystal structures, and has a single-phase and ε-phase crystal structure (ε-iron oxide type crystal structure).

The obtained ε-iron oxide powder (“ε-iron oxide” in Table 1) had an average particle size of 12 nm, an activation volume of 746 nm³, an anisotropy constant Ku of 1.2×10⁵ J/m³, and a mass magnetization as of 16 A·m²/kg.

### Method for Preparing Polyurethane Resin

### Preparation Method of Polyurethane 1

In Table 1, Polyurethane 1 is a polyurethane resin prepared by the following method.

100 parts of 2-aminoethanesulfonic acid (manufactured by Fujifilm Wako Pure Chemical Co., Ltd.) and 44.8 parts of potassium hydroxide (manufactured by Fujifilm Wako Pure Chemical Co., Ltd.: special grade reagent) were added to 300 parts of water and mixed, and then the mixture was heated to a temperature of 45° C. and stirred for 30 minutes. 208.1 parts of butyl glycidyl ether (manufactured by NOF Corporation) was added to the mixture after stirring, and then the mixture was heated to 70° C. and further stirred for 4 hours. 400 parts of toluene was added to the mixture and stirred for 10 minutes, and then a lower layer was separated off by allowing it to stand. The obtained lower layer was concentrated and dried using an evaporator to obtain 338 parts of a dried product of a sulfonic acid polyol.

100 parts of the sulfonic acid polyol obtained above, 466.3 parts of Blemmer GLM (manufactured by NOF Corporation), 667.9 parts of tricyclodecane dimethanol (manufactured by Tokyo Chemical Industry Co., Ltd.), 779.4 parts of BPX-1000 (manufactured by Tokyo Chemical Industry Co., Ltd.), and 4 parts of p-methoxyphenol (manufactured by Fujifilm Wako Pure Chemical Co., Ltd.) were added to 4,065 parts of cyclohexanone (manufactured by Tokyo Chemical Industry Co., Ltd.) and mixed, and the obtained mixture was heated to 50° C. to complete dissolution. 4 parts of Neostann U-600 (manufactured by Nitto Kasei Co., Ltd.) and 2051.4 parts of 4,4′-diphenylmethane diisocyanate (manufactured by Tokyo Chemical Industry Co., Ltd.) were added thereto and mixed, and the mixture was heated to a temperature of 50° C. and stirred for 4 hours. After that, a temperature of the mixture was heated to 100° C. and further stirred for 4 hours. 5,400 parts of cyclohexanone was added to the mixture after stirring, and then the mixture was cooled to a room temperature to obtain a resin solution having a polyether polyurethane (Polyurethane 1) concentration of 30 mass %. An average molecular weight of Polyurethane 1 was such that a number-average molecular weight (Mn) was 21,000 and a weight-average molecular weight (Mw) was 51,000.

### Preparation Method of Polyurethane 2

A solution of Polyurethane 2 was obtained by a method disclosed in Synthesis Example 1 of JP2004-005795A.

A glass transition temperature of Polyurethane 1 is 56° C., and a glass transition temperature of Polyurethane 2 is 150° C. The glass transition temperature is a temperature at a maximum point of a loss elastic modulus in the dynamic viscoelasticity measurement. The resin solution was applied onto a film forming support so that a thickness of the film after drying is 30 μm, dried in an atmosphere at an atmosphere temperature of 120° C. for 2 hours, and then peeled off from the film forming support to obtain a resin film. The obtained resin film was subjected to the dynamic viscoelasticity measurement using DMS6100 manufactured by Hitachi High-Tech Science Corporation as a dynamic viscoelasticity measuring device, and the glass transition temperature of each of Polyurethane 1 and Polyurethane 2 was obtained. The dynamic viscoelasticity measurement was performed under the following conditions by fixing a test piece having a width of 3.4 mm cut from the resin film to a dynamic viscoelasticity measuring device so that a distance between chucks is 10.0 mm.

### Measurement Condition

Measurement mode: tension

Frequency: 1 Hz (Hertz)

Strain amplitude: 0.1%

Scan temperature: −20.0° C. to 200.0° C.

Heating rate: 2.0° C./min

The resin solution obtained above was used for the preparation of the non-magnetic layer forming composition and the back coating layer forming composition. The binding agent amount in Table 1 is the amount (solid content) of Polyurethane 1 or Polyurethane 2 in the resin solution.

### Measurement Methods for Various Physical Properties

### (1) Various Thicknesses

From each magnetic tape of Examples and Comparative Examples, a sample for cross section observation was manufactured by a method described below. As SEM for SEM observation, FE-SEM S4800 manufactured by Hitachi, Ltd., which is a field emission (FE)-scanning electron microscope (SEM), was used.

(i) A sample having a size of 10 mm in a width direction and 10 mm in a longitudinal direction of the magnetic tape was cut out using a razor.

A protective film was formed on a magnetic layer surface of the cut sample to obtain a sample with a protective film. The formation of the protective film was performed by the following method.

A platinum (Pt) film (thickness of 30 nm) was formed on the magnetic layer surface of the sample by sputtering. The sputtering of the platinum film was performed under the following conditions.

### Sputtering Condition for Platinum Film

Target: Pt

Degree of vacuum in chamber of sputtering device: 7 Pa or less

Current value: 15 mA

A carbon film having a thickness of 100 to 150 nm was further formed on the above-manufactured sample with a platinum film. The formation of the carbon film was performed by a chemical vapor deposition (CVD) mechanism using a gallium ion (Ga+) beam provided in a focused ion beam (FIB) device used in the following (ii).

(ii) FIB processing using a gallium ion (Ga+) beam was performed on the sample with a protective film manufactured in the above (i) using a FIB device to expose a cross section of the magnetic tape. An acceleration voltage in FIB processing was 30 kV, and a probe current was 1,300 pA.

The sample for cross section observation exposed in this way was observed by SEM, and an SEM image of the cross section was acquired. A total of ten SEM images were acquired at ten randomly selected locations of the manufactured sample for cross section observation. Each SEM image was acquired as a secondary electron image captured at an acceleration voltage of 5 kV, an imaging magnification of 20,000 times, and 960 vertical pixels×1,280 horizontal pixels. An interface between the magnetic layer and the non-magnetic layer was specified by a method disclosed in a paragraph 0029 of JP2017-033617A. An interface between the non-magnetic layer and the non-magnetic support and an interface between the back coating layer and the non-magnetic support were specified by visually observing an SEM image. At any one position on each SEM image, an interval between the interface between the magnetic layer and the non-magnetic layer and the outermost surface on the magnetic layer side of the magnetic tape in a thickness direction was measured, and an arithmetic average of values obtained for 10 images was calculated as a thickness of the magnetic layer. At any one position on each SEM image, an interval between the interface of the non-magnetic layer with the magnetic layer and the interface of the non-magnetic layer with the non-magnetic support in a thickness direction was measured, and an arithmetic average of values obtained for 10 images was calculated as a thickness of the non-magnetic layer. At any one position on each SEM image, an interval between the outermost surface on the back coating layer side of the magnetic tape and the interface between the back coating layer and the non-magnetic support in a thickness direction was measured, and an arithmetic average of values obtained for 10 images was calculated as a thickness of the back coating layer. At any one position on each SEM image, an interval between the interface between the interface of the non-magnetic support with the back coating layer and the interface of the non-magnetic support with the non-magnetic layer in a thickness direction was measured, and an arithmetic average of values obtained for 10 images was calculated as a thickness of the non-magnetic layer.

### (2) Change Amount Δ1 and Change Amount Δ2

For each magnetic tape of Examples and Comparative Examples, the change amount Δ1 and the change amount Δ2 were obtained by the method described above using DMS6100 manufactured by Hitachi High-Tech Science Corporation as a dynamic viscoelasticity measuring device. A measurement temperature was set at a minimum temperature of 49.9° C., 51.4° C., 52.8° C., or the like at a temperature interval of 0.5° C. to 2.0° C., and a maximum temperature of 100.4° C.

### Evaluation Method (Tape Deformation)

In an evaluation environment of an atmosphere temperature of 35° C. and a relative humidity of 50%, tape deformation was evaluated by the following method using TMA/SS6100 manufactured by Hitachi High-Tech Science Corporation as an evaluation device.

A sample having a length of 15.0 mm and a width of 5.0 mm was cut out from a longitudinal direction of each magnetic tape of Examples and Comparative Examples, and the sample was fixed to the above-described evaluation device so that a distance between chucks is 10.0 mm, and a load was applied in a longitudinal direction in two stages. First stage: 39.2 mN for 2 hours, second stage: 392 mN for 20 hours. A sample length (length in longitudinal direction) was measured immediately before the end of the first stage and after the end of the second stage. Assuming that the sample length immediately before the end of the first stage (within 30 seconds) is a sample length 1 and the sample length after the end of the second stage is a sample length 2, the tape deformation amount was obtained as “tape deformation amount=(sample length 2)−(sample length 1)”. A unit of the tape deformation amount and the sample length is μm.

The above results are shown in Table 1 (Table 1-1 to Table 1-3).

TABLE 1-1

| | | | | | Comparative | | | | Comparative |
|---|---|---|---|---|---|---|---|---|---|
| | | Example 1 | Example 2 | Example 3 | Example 1 | Example 4 | Example 5 | Example 6 | Example 2 |
| Ferromagnetic powder | | BaFe | BaFe | BaFe | BaFe | BaFe | BaFe | BaFe | BaFe |
| Amount of | Polyurethane 1 | — | 300 | 500 | 800 | — | 300 | 500 | 800 |
| binding agent | Polyurethane 2 | 300 | 300 | 300 | 300 | 300 | 300 | 300 | 300 |
| of back coating | | | | | | | | | |
| layer and non- | | | | | | | | | |
| magnetic layer | | | | | | | | | |
| (unit: part) | | | | | | | | | |
| Thickness | Portion on back | 1.00 | 1.00 | 1.00 | 1.00 | 1.00 | 1.00 | 1.00 | 1.00 |
| (unit: μm) | coating layer | | | | | | | | |
| | side (back | | | | | | | | |
| | coating layer) | | | | | | | | |
| | Portion on | 0.50 | 0.50 | 0.50 | 0.50 | 0.20 | 0.20 | 0.20 | 0.20 |
| | magnetic layer | | | | | | | | |
| | side | | | | | | | | |
| | Non-magnetic | 0.43 | 0.43 | 0.43 | 0.43 | 0.13 | 0.13 | 0.13 | 0.13 |
| | layer | | | | | | | | |

| | | | | | | | | |
|---|---|---|---|---|---|---|---|---|
| Change amount Δ1 (magnetic | 0.000 | 0.005 | 0.012 | 0.015 | 0.001 | 0.004 | 0.010 | 0.014 |
| tape) | | | | | | | | |
| Change amount Δ2 | 0.000 | 0.011 | 0.020 | 0.032 | 0.001 | 0.008 | 0.016 | 0.026 |
| Tape deformation amount | 9.0 | 9.5 | 10.0 | 13.3 | 8.8 | 9.0 | 9.5 | 12.5 |
| (unit: μm) | | | | | | | | |

TABLE 1-2

| | | Example | Example | Example | Comparative | Example | Example |
|---|---|---|---|---|---|---|---|
| | | 7 | 8 | 9 | Example 3 | 10 | 11 |
| Ferromagnetic powder | | BaFe | BaFe | BaFe | BaFe | BaFe | BaFe |
| Amount of | Polyurethane 1 | — | 300 | 500 | 800 | — | 300 |
| binding agent | Polyurethane 2 | 300 | 300 | 300 | 300 | 300 | 300 |
| of back coating | | | | | | | |
| layer and non- | | | | | | | |
| magnetic layer | | | | | | | |
| (unit: part) | | | | | | | |
| Thickness | Portion on back | 0.50 | 0.50 | 0.50 | 0.50 | 0.50 | 0.50 |
| (unit: μm) | coating layer | | | | | | |
| | side (back | | | | | | |
| | coating layer) | | | | | | |
| | Portion on | 1.00 | 1.00 | 1.00 | 1.00 | 0.50 | 0.50 |
| | magnetic layer | | | | | | |
| | side | | | | | | |
| | Non-magnetic | 0.93 | 0.93 | 0.93 | 0.93 | 0.43 | 0.43 |
| | layer | | | | | | |

| | | | | | | |
|---|---|---|---|---|---|---|
| Change amount Δ1 (magnetic | 0.000 | 0.006 | 0.012 | 0.016 | 0.000 | 0.003 |
| tape) | | | | | | |
| Change amount Δ2 | 0.000 | 0.010 | 0.020 | 0.030 | 0.000 | 0.007 |
| Tape deformation amount | 8.9 | 9.5 | 9.8 | 13.0 | 8.6 | 9.2 |
| (unit: μm) | | | | | | |

| | | Example | Example | Example | Example | Example | Example |
|---|---|---|---|---|---|---|---|
| | | 12 | 13 | 14 | 15 | 16 | 17 |
| Ferromagnetic powder | | BaFe | BaFe | BaFe | BaFe | BaFe | BaFe |
| Amount of | Polyurethane 1 | 500 | 800 | | 300 | 500 | 800 |
| binding agent | Polyurethane 2 | 300 | 300 | 300 | 300 | 300 | 300 |
| of back coating | | | | | | | |
| layer and non- | | | | | | | |
| magnetic layer | | | | | | | |
| (unit: part) | | | | | | | |
| Thickness | Portion on back | 0.50 | 0.50 | 0.50 | 0.50 | 0.50 | 0.50 |
| (unit: μm) | coating layer | | | | | | |
| | side (back | | | | | | |
| | coating layer) | | | | | | |
| | Portion on | 0.50 | 0.50 | 0.20 | 0.20 | 0.20 | 0.20 |
| | magnetic layer | | | | | | |
| | side | | | | | | |
| | Non-magnetic | 0.43 | 0.43 | 0.13 | 0.13 | 0.13 | 0.13 |
| | layer | | | | | | |

| | | | | | | |
|---|---|---|---|---|---|---|
| Change amount Δ1 (magnetic | 0.008 | 0.011 | 0.001 | 0.002 | 0.004 | 0.005 |
| tape) | | | | | | |
| Change amount Δ2 | 0.013 | 0.020 | 0.001 | 0.003 | 0.006 | 0.009 |
| Tape deformation amount | 9.4 | 11.5 | 7.9 | 8.0 | 8.2 | 8.7 |
| (unit: μm) | | | | | | |

TABLE 1-3

| | | | | | Comparative | | |
|---|---|---|---|---|---|---|---|
| | | Example 18 | Example 19 | Example 20 | Example 4 | Example 21 | Example 22 |
| Ferromagnetic powder | | BaFe | BaFe | BaFe | BaFe | BaFe | BaFe |
| Amount of | Polyurethane 1 | — | 300 | 500 | 800 | — | 300 |
| binding agent | Polyurethane 2 | 300 | 300 | 300 | 300 | 300 | 300 |
| of back coating | | | | | | | |
| layer and non- | | | | | | | |
| magnetic layer | | | | | | | |
| (unit: part) | | | | | | | |
| Thickness | Portion on back | 0.20 | 0.20 | 0.20 | 0.20 | 0.20 | 0.20 |
| (unit: μm) | coating layer | | | | | | |
| | side (back | | | | | | |
| | coating layer) | | | | | | |
| | Portion on | 1.00 | 1.00 | 1.00 | 1.00 | 0.50 | 0.50 |
| | magnetic layer | | | | | | |
| | side | | | | | | |
| | Non-magnetic | 0.93 | 0.93 | 0.93 | 0.93 | 0.43 | 0.43 |
| | layer | | | | | | |

| | | | | | | |
|---|---|---|---|---|---|---|
| Change amount Δ1 (magnetic | 0.001 | 0.004 | 0.010 | 0.013 | 0.000 | 0.003 |
| tape) | | | | | | |
| Change amount Δ2 | 0.001 | 0.008 | 0.016 | 0.024 | 0.000 | 0.006 |
| Tape deformation amount | 8.7 | 9.0 | 9.4 | 12.0 | 8.1 | 8.3 |
| (unit: μm) | | | | | | |

| | | Example 23 | Example 24 | Example 25 | Example 26 | Example 27 |
|---|---|---|---|---|---|---|
| Ferromagnetic powder | | BaFe | BaFe | SrFe1 | SrFe2 | ε-iron |
| | | | | | | oxide |
| Amount of | Polyurethane 1 | 500 | 800 | — | — | — |
| binding agent | Polyurethane 2 | 300 | 300 | 300 | 300 | 300 |
| of back coating | | | | | | |
| layer and non- | | | | | | |
| magnetic layer | | | | | | |
| (unit: part) | | | | | | |
| Thickness | Portion on back | 0.20 | 0.20 | 1.00 | 1.00 | 1.00 |
| (unit: μm) | coating layer | | | | | |
| | side (back | | | | | |
| | coating layer) | | | | | |
| | Portion on | 0.50 | 0.50 | 0.50 | 0.50 | 0.50 |
| | magnetic layer | | | | | |
| | side | | | | | |
| | Non-magnetic | 0.43 | 0.43 | 0.43 | 0.43 | 0.43 |
| | layer | | | | | |

| | | | | | |
|---|---|---|---|---|---|
| Change amount Δ1 (magnetic | 0.006 | 0.008 | 0.000 | 0.001 | 0.000 |
| tape) | | | | | |
| Change amount Δ2 | 0.010 | 0.015 | 0.001 | 0.000 | 0.001 |
| Tape deformation amount | 8.3 | 8.8 | 8.9 | 8.8 | 9.0 |
| (unit: μm) | | | | | |

As shown in Table 1, the magnetic tapes of Examples 1 to 27 in which a deformation amount Δ1 is 0.000 or more and 0.012 or less have smaller tape deformation amounts obtained by the above-described evaluation method than the magnetic tapes of Comparative Examples 1 to 4. It can be said that the smaller the tape deformation amount obtained by the above-described evaluation method is, the more the deformation during running and/or storage, that is, in a state where a stress is applied is suppressed.

An aspect of the present invention is useful in technical fields of various types of data storage such as data back-up and archive.

What is claimed is:

1. A magnetic tape comprising:
a non-magnetic support; and
a magnetic layer including ferromagnetic powder,
wherein a change amount Δ1 of a loss tangent tan δ at a measurement temperature in a range of 50° C. to 100° C. before and after heating at 70° C. for 10 hours is 0.000 or more and 0.012 or less.

2. The magnetic tape according to claim 1,
wherein the magnetic tape has the magnetic layer on one surface side of the non-magnetic support and has a back coating layer including non-magnetic powder on the other surface side, and
a change amount Δ2 obtained by the following formula is 0.000 or more and 0.020 or less,
Δ2=Δa×[Da/(Da+Db)]+Δb×[Db/(Da+Db)]
in the formula, Da is a thickness of a portion on the magnetic layer side on the non-magnetic support, Δa is a change amount of a loss tangent tan δ of the portion on the magnetic layer side at a measurement temperature in a range of 50° C. to 100° C. before and after the heating, Db is a thickness of a portion on the back coating layer side on the non-magnetic support, and Δb is a change amount of a loss tangent tan δ of the portion on the back coating layer side at a measurement temperature in a range of 50° C. to 100° C. before and after the heating.

3. The magnetic tape according to claim 2,
wherein the thickness Da of the portion on the magnetic layer side is 0.20 μm or more and 0.50 μm or less, and
the thickness Db of the portion on the back coating layer side is 0.20 μm or more and 1.50 μm or less.

4. The magnetic tape according to claim 2,
wherein the thickness Da of the portion on the magnetic layer side is 0.20 μm or more and 1.00 μm or less, and
the thickness Db of the portion on the back coating layer side is 0.20 μm or more and 0.90 μm or less.

5. The magnetic tape according to claim 1, further comprising:
a non-magnetic layer including non-magnetic powder between the non-magnetic support and the magnetic layer.

6. The magnetic tape according to claim 2,
wherein the back coating layer includes one or more types of non-magnetic powder selected from the group consisting of inorganic powder and carbon black.

7. The magnetic tape according to claim 1,
wherein the ferromagnetic powder is hexagonal ferrite powder.

8. The magnetic tape according to claim 1,
wherein the ferromagnetic powder is ε-iron oxide powder.

9. A magnetic tape cartridge comprising a magnetic tape,
wherein the magnetic tape is a magnetic tape comprising:
a non-magnetic support; and
a magnetic layer including ferromagnetic powder,
wherein a change amount Δ1 of a loss tangent tan δ at a measurement temperature in a range of 50° C. to 100° C. before and after heating at 70° C. for 10 hours is 0.000 or more and 0.012 or less.

10. The magnetic tape cartridge according to claim 9,
wherein the magnetic tape has the magnetic layer on one surface side of the non-magnetic support and has a back coating layer including non-magnetic powder on the other surface side, and
a change amount Δ2 obtained by the following formula is 0.000 or more and 0.020 or less,
Δ2=Δa×[Da/(Da+Db)]+Δb×[Db/(Da+Db)]
in the formula, Da is a thickness of a portion on the magnetic layer side on the non-magnetic support, Δa is a change amount of a loss tangent tan δ of the portion on the magnetic layer side at a measurement temperature in a range of 50° C. to 100° C. before and after the heating, Db is a thickness of a portion on the back coating layer side on the non-magnetic support, and Δb is a change amount of a loss tangent tan δ of the portion on the back coating layer side at a measurement temperature in a range of 50° C. to 100° C. before and after the heating.

11. The magnetic tape cartridge according to claim 10,
wherein the thickness Da of the portion on the magnetic layer side is 0.20 μm or more and 0.50 μm or less, and
the thickness Db of the portion on the back coating layer side is 0.20 μm or more and 1.50 μm or less.

12. The magnetic tape cartridge according to claim 10,
wherein the thickness Da of the portion on the magnetic layer side is 0.20 μm or more and 1.00 μm or less, and
the thickness Db of the portion on the back coating layer side is 0.20 μm or more and 0.90 μm or less.

13. A magnetic recording and reproducing apparatus comprising a magnetic tape,
wherein the magnetic tape is a magnetic tape comprising:
a non-magnetic support; and
a magnetic layer including ferromagnetic powder,
wherein a change amount Δ1 of a loss tangent tan δ at a measurement temperature in a range of 50° C. to 100° C. before and after heating at 70° C. for 10 hours is 0.000 or more and 0.012 or less.

14. The magnetic recording and reproducing apparatus according to claim 13,
wherein the magnetic tape has the magnetic layer on one surface side of the non-magnetic support and has a back coating layer including non-magnetic powder on the other surface side, and
a change amount Δ2 obtained by the following formula is 0.000 or more and 0.020 or less,
Δ2=Δa×[Da/(Da+Db)]+Δb×[Db/(Da+Db)]
in the formula, Da is a thickness of a portion on the magnetic layer side on the non-magnetic support, Δa is a change amount of a loss tangent tan δ of the portion on the magnetic layer side at a measurement temperature in a range of 50° C. to 100° C. before and after the heating, Db is a thickness of a portion on the back coating layer side on the non-magnetic support, and Δb is a change amount of a loss tangent tan δ of the portion on the back coating layer side at a measurement temperature in a range of 50° C. to 100° C. before and after the heating.

15. The magnetic recording and reproducing apparatus according to claim 14,
wherein the thickness Da of the portion on the magnetic layer side is 0.20 μm or more and 0.50 μm or less, and
the thickness Db of the portion on the back coating layer side is 0.20 μm or more and 1.50 μm or less.

16. The magnetic recording and reproducing apparatus according to claim 14,
wherein the thickness Da of the portion on the magnetic layer side is 0.20 μm or more and 1.00 μm or less, and
the thickness Db of the portion on the back coating layer side is 0.20 μm or more and 0.90 μm or less.
